(19) United States
(12) Patent Application Publication
(10) Pub. No.: US 2002/0044287 A1
(43) Pub. Date: Apr. 18, 2002

(54) Point diffraction interferometer, manufacturing method for reflecting mirror, and projection exposure apparatus

(75) Inventor: Katsura Otaki, Tokyo (JP)

Correspondence Address: OLIFF & BERRIDGE, PLC, P.O. BOX 19928, ALEXANDRIA, VA, 22320, US

(73) Assignee: NIKON CORPORATION

(21) Appl. No.: 09/780,414

(22) Filed: Feb. 12, 2001

(30) Foreign Application Priority Data
Feb. 17, 2000 (JP) P2000-039092

(51) Int. Cl. G01B 9/02

(52) U.S. Cl. 356/521; 356/513

(57) ABSTRACT

The invention relates to a point diffraction interferometer which measures a profile irregularity on a surface to be measured by, irradiating light irradiated from a light source to a pinhole mirror via a collective optical system, irradiating a part of the light diffracted from a pinhole provided in the pinhole mirror to the surface to be measured as a luminous flux for measurement, making the luminous flux for measurement reflected by the surface to be measured interfere with a reference luminous flux which is an other part of light diffracted from the pinhole, and detecting the state of an interference fringe caused by the interference. In the invention, a diameter range of the pinhole is: λ/2≦φPH≦λ/NA (wherein λ is a wavelength of light irradiated from the light source, NA is a numerical aperture of the collective optical system, and φ PH is a diameter of the pinhole).

### BACKGROUND OF THE INVENTION

1. Field of the Invention

The present invention relates to a point diffraction interferometer used for high precision measurement of a profile irregularity, a manufacturing method for a reflecting mirror, and a projection exposure apparatus.

2. Description of the Related Art

Recently, with the miniaturization of semiconductor integrated circuit elements, an exposure method (lithography technique) using X-rays has been developed, in order to improve the resolution of an optical system, which is limited by the diffraction limit of light.

A catoptric system as an optical system of an X-ray lithography apparatus, is constituted of a plurality of reflecting mirrors including an aspherical surface.

The integrated wave front aberration of the optical system used for X-ray lithography should be λ/14 rms or less, and hence precision as high as 0.2 nmrms is required for the profile irregularity (machining precision) of each mirror. For machining with such a high precision, higher precision, for example, measurement precision as high as about 0.1 nmrms is required for shape measurement of the reflecting mirror.

Generally, a point diffraction interferometer (hereinafter referred to as “PDI”) is used as means for extra-precision measurement. The point diffraction interferometer is divided roughly into one for generating divergent spherical waves by means of a pinhole, and one for generating divergent spherical waves by means of fibers.

FIG. 6 is a diagram illustrating the principle of a conventional PDI which generates divergent spherical waves by the pinhole (hereinafter referred to as a “pinhole method”). Reference symbol 1 denotes a collective lens, 2 denotes a pinhole mirror, 3 denotes a test mirror, and 4 denotes a CCD. As the pinhole mirror 2, there is used one constituted of a transparent substrate and a metal film such as chromium formed on the substrate, other than the one obtained by forming a pinhole in a metal plate.

Light irradiated from a light source (not shown) is collected onto a pinhole 2a by the collective lens 1, and a part thereof is diffracted at the time of transmission through the pinhole 2a formed in the pinhole mirror 2, becoming divergent spherical waves which are diffused to the space.

A part (W1) of the divergent spherical waves is used as a reference wave front.

An other part (W2) of the divergent spherical waves is used as a measurement wave front, and is irradiated toward the test mirror 3, and reflected by a test surface 3a (W2′), as well as being collected toward the pinhole mirror 2.

The collected measurement wave front (W2′) is again reflected by the pinhole mirror 2 (W2″), and interferes with the reference wave front (W1) to thereby form an interference fringe on the CCD 4. A piezo device is provided on a holder (not shown) on the CCD 4, which slightly vibrates a test object to detect a change in the interference fringe with the CCD, and the profile irregularity is calculated by analyzing this change.

FIG. 7 is a diagram showing the principle of a conventional PDI which generates divergent spherical waves by fibers (hereinafter referred to as a “fiber method”). Reference symbol 5 denotes a single-mode fiber with a reflection increasing coating formed on the output surface.

Light output from a light source (not shown) is irradiated to the single-mode fiber 5 via the collective lens 1. The luminous flux emitted from this fiber 5 forms ideal spherical waves. Therefore, if the single-mode fiber is applied to a point diffraction interferometer of the fiber method, instead of the pinhole mirror described above, the surface shape of a test surface can be measured by the same principle as that of the pinhole method.

However, with the above-described conventional PDI, errors occur due to various causes, and sufficient measurement precision cannot be obtained. As the main causes for errors, there can be mentioned the followings:

(1) A case due to residual aberration of the collective lens

As described above, in the pinhole method PDI, the collective lens 1 is used for collecting the laser radiation onto the pinhole 2a formed on the pinhole mirror 2.

This collective lens 1 is formed of a plurality of lenses, and generally has aberration. Therefore, the collecting spot on the pinhole 2a is generally distorted due to the aberration. Accordingly, if the pinhole diameter is too large, the wave front after transmission through the pinhole 2a remains distorted, and ideal spherical waves cannot be obtained. As a result, high precision measurement cannot be performed.

(2) A case attributable to polarized light

In either the pinhole method PDI or the fiber method PDI, laser radiation is used as a light source, and in general, polarized light (linearly polarized light) is irradiated onto the test object 3.

If linearly polarized light is used, there is caused a problem of a phase change in the reflecting wave front, as shown below. This means a distortion of the reflecting wave front, and as a result, high precision measurement cannot be performed.

Considering the pinhole method PDI shown in FIG. 6 as an example, the wave front (W2′) reflected by the test surface is returned to the pinhole mirror 2 at an angle, and again reflected by the pinhole mirror 2. At this time, since the phase in the reflected wave is different depending on the incident angle of the reflected wave from the test surface onto the pinhole 2a, the reflected wave front (W2″) is distorted. The surface shape measurement of the test object is performed by interference between the reference wave fronts W1 and W2″, and hence high precision measurement is not possible by the distorted reflected wave front (W2″). That is to say, it is impossible to measure the test object with a profile irregularity of 0.2 nm.

(3) Control of the reflected phase difference

The reflected wave front (W2′) from the test surface 3a is scattered at the time of being collected to the vicinity of the pinhole 2a formed in the pinhole mirror 2, and as a result, the wave front is disturbed.

FIG. 9 is a graph showing an enlargement ratio of the reflected wave front (disturbance in the reflected wave front) with respect to the pinhole diameter formed on the pinhole mirror where a predetermined reflected phase difference occurs. Here, the enlargement ratio of the reflected wave front indicates the degree that the reflected wave front from the test surface 3a is scattered and enlarged by the pinhole 2a formed in the pinhole mirror 2.

That is to say, when the enlargement ratio of the reflected wave front is 1, this means that the wave front (W2′), which is the shape information from the test surface 3a, is faithfully reflected on the reflected wave front (W2′). Moreover, when the enlargement ratio is larger than 1, this means that the wave front (W2′), being the shape information from the test surface 3a, is not faithfully reflected on the reflected wave front (W2″), and the wave front is disturbed due to the reflection on the pinhole mirror 2. For example, when the enlargement ratio of the reflected wave front is 2, this means that the distortion of the reflected wave front (W2″) after having been reflected on the pinhole mirror 2 is twice as large as the distortion of the reflected wave front (W2′) in the test surface 3a.

In addition, the reflection phase difference stands for a difference in the reflection phase between the inside of the pinhole (substrate) and the outside of the pinhole (reflection coating).

In FIG. 9, calculation is performed, assuming that the wavelength λ=633 nm, the numerical aperture NA of the test surface is 0.2, and the reflection coating is a chromium film having a film thickness of 200 nm.

From FIG. 9, it can be seen that, for example, in the case of a pinhole diameter of 1.5 μm, the wave front shape is enlarged up to twice due to scattering in the pinhole, making it impossible to perform high precision measurement.

In view of the above problems, it is an object of the present invention to provide a point diffraction interferometer which can measure the profile irregularity of a test object having a large NA with high precision (capable of measuring a profile irregularity of about 0.2 nmrms). Moreover, it is another object of the present invention to provide a manufacturing method for a reflecting mirror and a projection exposure apparatus comprising a reflecting mirror manufactured by this manufacturing method.

### SUMMARY OF THE INVENTION

The present invention relates to a point diffraction interferometer which measures a profile irregularity on a surface to be measured by, irradiating light irradiated from a light source to a pinhole mirror via a collective optical system, irradiating a part of the light diffracted from a pinhole provided in the pinhole mirror to the surface to be measured as a luminous flux for measurement, making the luminous flux for measurement reflected by the surface to be measured interfere with a reference luminous flux which is an other part of light diffracted from the pinhole, and detecting the state of an interference fringe caused by the interference.

In particular, the present invention is characterized in that, in the above point diffraction interferometer, a diameter range of the pinhole is:

λ/2≦φPH≦λ/NA,

wherein λ is a wavelength of light irradiated from the light source, NA is a numerical aperture of the collective optical system, and φ PH is a diameter of the pinhole.

By making the pinhole diameter in a predetermined range, even if the wave front of light irradiated onto the pinhole mirror is distorted due to aberration, ideal spherical waves can be obtained after having been transmitted through the pinhole, and as a result, shape measurement with high precision becomes possible.

Moreover, the present invention is characterized in that, in the above point diffraction interferometer, a range of a numerical aperture of the collective optical system is:

NA≦λ/φPH,

0<NA<1,

wherein λ is a wavelength of light irradiated from the light source, NA is a numerical aperture of the collective optical system, and φ PH is a diameter of the pinhole.

The present invention is also characterized in that, in the above point diffraction interferometer, the light irradiated onto the pinhole is elliptically polarized light, and

0.5<ε<2,

wherein ε is ellipticity of the elliptically polarized light (ratio of a minor axis to a major axis).

By using the elliptically polarized light within a predetermined range as the light irradiated onto the pinhole mirror, the angular dependence in the phase variation of the reflected wave front in the pinhole mirror can be made small, and as a result, high precision shape measurement becomes possible.

Moreover, the present invention is characterized in that, in the above point diffraction interferometer, the pinhole mirror has a transparent substrate, a first reflection coating and a second reflection coating comprising the pinhole, formed sequentially on this substrate.

Moreover, when the pinhole diameter is 0.5 μm or larger, it is desired that:

0.5≦γ<1;

φ=Δ+360°×N(−45°≦Δ≦45°, N=integer),

wherein

γ is internal reflectivity of the pinhole (reflection by the first reflection coating)/external reflectivity of the pinhole (reflection by the second reflection coating), and φ is a phase difference between the internal reflectivity and the external reflectivity of the pinhole.

According to the above construction, the enlargement ratio of the reflected wave front (disturbance in the reflected wave front) can be made small, in the pinhole mirror where a predetermined phase difference occurs, and as a result, high precision shape measurement becomes possible.

Moreover, the present invention is characterized in that, in the above point diffraction interferometer, a dielectric multilayer reflection coating is formed on the surface side to be measured of the pinhole mirror.

According to the above construction, the incident angle dependence in the phase of the reflected wave from the test object decreases, thereby enabling high precision shape measurement.

The present invention is also characterized by a point diffraction interferometer which measures a profile irregularity of a surface to be measured by, irradiating polarized light irradiated from a light source to a polarization retention fiber, irradiating a part of the polarized light emitted from this fiber to the surface to be measured as a luminous flux for measurement, making the luminous flux for measurement reflected by the surface to be measured interfere with a reference luminous flux which is an other part of polarized light emitted from the fiber, and detecting the state of an interference fringe caused by the interference, wherein a λ/2 plate comprising a rotatable mechanism is arranged between the light source and the polarization retention fiber.

An error resulting from the phase change of the reflected wave front is compensated, by superposing first data obtained by measuring the test object by a predetermined polarized light and second data obtained by measuring the test object after having rotated the λ/2 plate through 90°. As a result, high precision shape measurement becomes possible.

The present invention is also characterized by a point diffraction interferometer which measures a profile irregularity of a surface to be measured by, irradiating light irradiated from a light source to a single-mode fiber, irradiating a part of the light emitted from this fiber to the surface to be measured as a luminous flux for measurement, making the luminous flux for measurement reflected by the surface to be measured interfere with a reference luminous flux which is an other part of polarized light emitted from the fiber, and detecting the state of an interference fringe caused by the interference, wherein a dielectric multilayer reflection coating is formed on an end face on the surface side to be measured of the single-mode fiber.

According to the above construction, the incident angle dependence in the phase of the reflected wave from the test object decreases, thereby enabling high precision shape measurement.

The present invention is also characterized by a manufacturing method for a reflecting mirror in which a multilayer film obtained by alternately laminating a heavy element layer and a light element layer on a substrate is formed, which comprises at least a step for measuring the profile irregularity, using either of the above described point diffraction interferometers.

Moreover, the present invention is characterized by a projection exposure apparatus comprising an illumination optical system for illuminating a mask by soft X-rays, and a projection optical system for projection exposing a pattern formed on this mask onto a photosensitive substrate, wherein the illumination optical system or the projection optical system comprises the reflecting mirror manufactured by the manufacturing method for a reflecting mirror described above.

### BRIEF DESCRIPTION OF THE DRAWINGS

FIG. 1 is a graph showing wave front aberration of divergent spherical waves after having been transmitted through a pinhole, with respect to the pinhole diameter.

FIG. 2 is a diagram showing the outline of a pinhole method PDI of a second embodiment of the present invention.

FIG. 3 is a diagram showing the outline of a fiber method PDI of a third embodiment of the present invention.

FIG. 4 is a schematic sectional view of a pinhole mirror applied to a pinhole method PDI of a fourth embodiment of the present invention.

FIG. 5 is a graph showing an enlargement ratio of a reflected wave front from a test object, with respect to a reflection phase difference between pinhole internal reflection and pinhole external reflection, in the case where the pinhole diameter is 1 μm.

FIG. 6 is a diagram showing the principle of a PDI which generates divergent spherical waves by means of a pinhole.

FIG. 7 is a diagram showing the principle of a PDI which generates divergent spherical waves by means of fibers.

FIG. 8 is a diagram showing a phase of the reflected wave front with respect to the NA of the incident angle to a pinhole mirror.

FIG. 9 is a graph showing a relation between the pinhole diameter in a pinhole mirror where a predetermined reflection phase difference occurs, and an enlargement ratio of the reflected wave front (disturbance in the reflected wave front).

FIG. 10 is a diagram showing one example of EUVL.

### DETAILED DESCRIPTION OF THE PREFERRED EMBODIMENTS

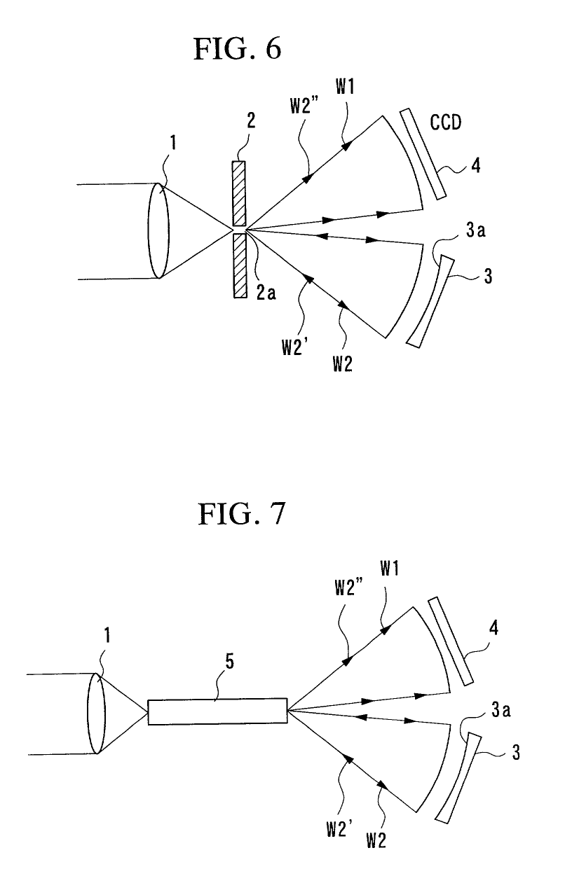

Embodiments of a PDI according to the present invention will now be described with reference to drawings. In the embodiments of the present invention, members having basically the same structure as that of the PDI shown in FIG. 6 are denoted by the same reference symbol as in FIG. 6, and the description thereof is omitted.

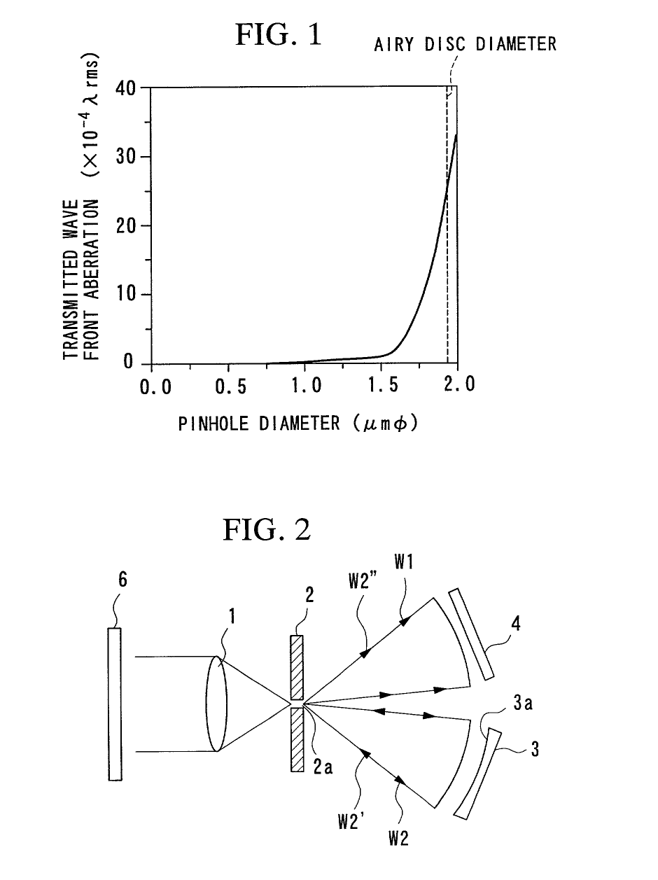

FIG. 1 is a graph showing wave front aberration of divergent spherical waves after having been transmitted through a pinhole, with respect to the pinhole diameter (μm φ, φ shows a diameter).

Here, the transmitted wave front aberration is expressed in a unit of 1×10⁻⁴ λrms.

Moreover, the calculation was performed, using known scalar diffraction theory.

The calculation conditions are as follows:

Laser wavelength λ=633 nm;

NA of the collective lens 1 is 0.4;

NA of divergent spherical waves after having been transmitted through the pinhole is 0.4; and

Comatic aberration of 0.05 λrms is used as the aberration of the collective lens 1. The wave front aberration was calculated, designating the NA of divergent spherical waves as 0.4. Therefore, the NA used for the measurement becomes ½ of this, that is, 0.2.

From FIG. 1, it is seen that when the pinhole diameter becomes larger than 1.5 μm, the aberration abruptly increases. Since the collecting spot diameter (Airy disk diameter) under the conditions is 1.93 μm, it is seen that the pinhole diameter is preferably a collecting spot diameter (Airy disc diameter)×0.8 or below.

That is to say, since the Airy disk diameter=λ×NA×1.22 (λ: laser wavelength, NA: numerical aperture of the collective lens), the pinhole diameter becomes equal to λ/NA×1.22×0.8≈λ/NA.

On the other hand, it is known that when the pinhole diameter becomes ½ or less of the laser wavelength, the light quantity abruptly decreases. When the light quantity decreases, CCD noise increases, and hence an S/N ratio for sufficiently detecting the profile irregularity of the test object cannot be obtained. As a result, high precision measurement becomes impossible.

Accordingly, the preferable range of the pinhole diameter φ PH becomes:

λ/2≦φPH≦λ/NA.

That is to say, a first embodiment of the present invention is such that the range of the pinhole diameter φ PH is set to the above described range, in the pinhole method PDI.

However, if a metal plate or metal film forming the pinhole mirror is thinner than a predetermined thickness, the light irradiated onto the pinhole is not shielded sufficiently, and hence it is not possible to transmit only the necessary portion of light. That is to say, it is not possible to remove the aberration portion from light including aberration of the collective lens, and hence ideal spherical waves cannot be generated. Therefore, in the case of, for example, a chromium film, a film thickness of 100 nm or more is necessary, and in the case of an aluminum film, a film thickness of 50 nm or more is necessary.

It is also preferable that the pinhole is a perfect circle, from the viewpoint of aberration occurrence. This is because when the pinhole is distorted, aberration occurs due to the influence thereof.

Moreover, in the case where measurement is carried out using a pinhole mirror having a predetermined pinhole diameter, it is preferred to select a collective optical system having a numerical aperture in the following range. That is to say, the range of the preferable numerical aperture in the collective optical system is:

NA≦λ/φPH, 0<NA<1.

FIG. 2 is a diagram showing the outline of a pinhole method PDI of a second embodiment of the present invention. In the pinhole method PDI of the second embodiment, a λ/4 plate 6 for changing linearly polarized light to circularly polarized light is disposed in front of the collective lens 1 of a conventional pinhole method PDI shown in FIG. 6 described above.

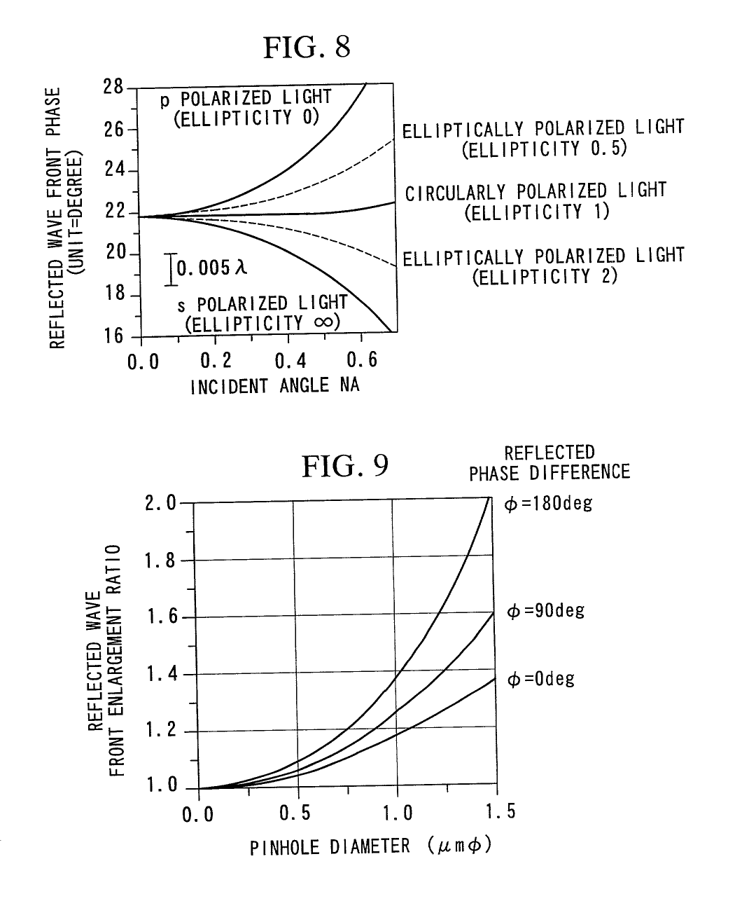

FIG. 8 shows a phase of the reflected wave front with respect to an incident angle (NA) to the pinhole mirror 2. The incident angle onto the pinhole mirror 2 is expressed by NA on the X-axis, and a phase of the reflected wave front in the pinhole mirror 2 is plotted on the Y-axis. The calculation was carried out, assuming that the laser wavelength λ is 633 nm, and the reflection coating is a chromium film having a film thickness of 200 nm. Here, p polarized light is polarized light parallel to the page in FIG. 6, and s polarized light is polarized light perpendicular to the page in FIG. 6. Other constructions are the same as in FIG. 6.

From the calculation result shown in FIG. 8, it is seen that both the s polarized light and the p polarized light are distorted by about 0.005 λ in the range of NA=0 to 0.4. Therefore, it can be expected that if a measurement is carried out using circularly polarized light, deviation in the phase of the s polarized light and the p polarized light can be compensated.

According to the calculation result shown in FIG. 8, when measurement is carried out using circularly polarized light, the wave front distortion has a value as small as:

about 0.0001 λrms in the range of NA=0 to 0.4; and

0.001 λrms or less in the range of NA=0 to 0.6.

As a result, regarding the light irradiated onto the pinhole mirror, the circularly polarized light has higher precision than that of the linearly polarized light. Also, elliptically polarized light close to the circularly polarized light has a large effect in suppressing an error. From FIG. 8, it is also understood that the elliptically polarized light having an ellipticity of from 0.5 to 2 can suppress measurement error.

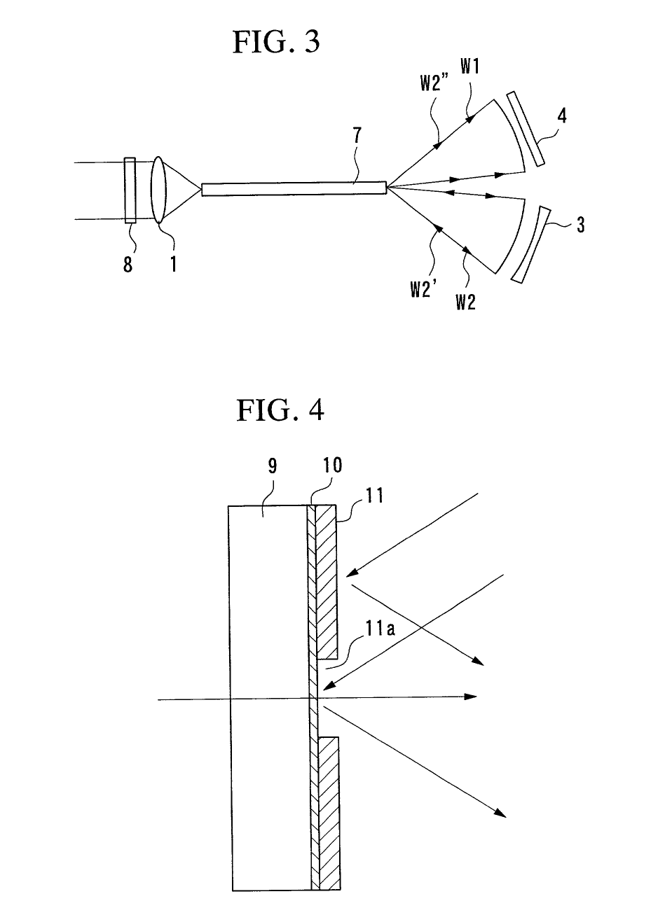

FIG. 3 is a diagram showing the outline of a fiber method PDI of a third embodiment of the present invention. In the fiber method PDI of this embodiment, a single-mode fiber 5 of the conventional fiber method PDI shown in FIG. 7 described above is replaced with a polarization retention fiber 7, and a rotatable λ/2 plate 8 is arranged in front of the fiber 7. Other constructions are the same as in FIG. 7.

With this PDI, at first, a test object 3 is measured by p polarized light, to obtain measurement data (first measurement data). Next the λ/2 plate 8 is rotated by 45° to change the p polarized light to the s polarized light, to measure the test object 3 with the s polarized light, to thereby obtain measurement data (second measurement data). Then, both measurement data are superposed. As a result, an error resulting from the phase change of the reflected wave front is compensated.

The polarized light used for the measurement need not be the p polarized light or the s polarized light, and the plane of polarization in one of the polarized light has only to be rotated through 90° with respect to the other polarized light.

On the other hand, a PDI in which the single-mode fiber in the conventional fiber method PDI is replaced with a polarization retention fiber is also applicable as an embodiment of the present invention. At the time of measurement of a test object 3 by this PDI, the test object is first measured at a predetermined set position, to obtain measurement data (first measurement data). Next the test object is rotated by 90° from the set position for measurement, to thereby obtain measurement data (second measurement data). Then, by superposing both measurement data, an error is compensated. In this case, at the time of superposing both measurement data, it is necessary to perform superposition after the second measurement data is rotated by −90°, corresponding to the fact that the test object has been rotated by 90°.

Moreover, in order to decrease the incident angle dependence of the phase of the reflected wave front from the test object, a PDI in which a dielectric multilayer film comprising a pinhole on a pinhole mirror (one in which a pinhole is formed on a metal substrate, or one in which a metal film comprising a pinhole is formed on a transparent substrate) of the conventional pinhole method PDI shown in FIG. 6 described above is also applicable as an embodiment of the present invention. The dielectric multilayer film may be formed on a transparent substrate within the pinhole.

Furthermore, a PDI which has a dielectric multilayer film on a fiber reflecting surface (a metal film comprising a pinhole) of the fiber method PDI shown in FIG. 7 described above is also applicable as an embodiment of the present invention.

On the other hand, with a normal polarization optical system (for example, magneto-optic recording system or the like), if there is polarization dependence of the reflected phase in the reflecting mirror, the polarized light is disturbed. Therefore, a reflecting mirror in which a multilayer reflection coating comprising only a dielectric is formed on a substrate is generally used.

If this is directly applied to the pinhole method PDI, and the reflecting mirror is replaced by a pinhole mirror in which a multilayer reflection coating comprising only a dielectric having a pinhole is formed on a transparent substrate, it cannot perform the function of the pinhole. This is because with the reflection increasing film comprising only a dielectric having a pinhole, the light in the vicinity of the pinhole penetrates into the inside of the dielectric multilayer film. That is to say, different from the metal film, the reflection increasing film having only a dielectric cannot confine the light, and as a result, the wave front after pinhole transmission does not form ideal spherical waves, and is distorted. From this reason, it is necessary for the pinhole mirror used for the PDI to have a construction in which a metal film comprising a pinhole and a dielectric multilayer film comprising a pinhole are sequentially formed on a transparent substrate.

In a pinhole method PDI of the fourth embodiment of the present invention, the pinhole mirror 2 in the conventional pinhole method PDI shown in FIG. 6 described above is replaced by a pinhole mirror shown below. Other constructions are the same as in FIG. 6.

FIG. 4 is a schematic sectional view of a pinhole mirror of the pinhole method PDI of the fourth embodiment. This pinhole mirror is constituted of a glass substrate 9, a first reflection coating 10 sequentially formed on this substrate 9, and a second reflection coating 11 comprising a pinhole 11a.

The wave front W2′ reflected from a test surface of a test object 3 penetrates through a pinhole 11a formed on the second reflection coating 11, and is reflected by the first reflection coating 10 (hereinafter referred to as “pinhole internal reflection”), and is also reflected by the second reflection coating 11 (hereinafter referred to as “pinhole external reflection”). In this case, by forming a reflection coating inside the pinhole (first reflection coating), the pinhole internal reflectivity is improved. Therefore, scattering due to the pinhole 11a can be suppressed to a minimum, by designating the phase difference between the pinhole internal reflection and the pinhole external reflection as 2π× integer, thereby generating the same effect as in the case where a pinhole is substantially non existent.

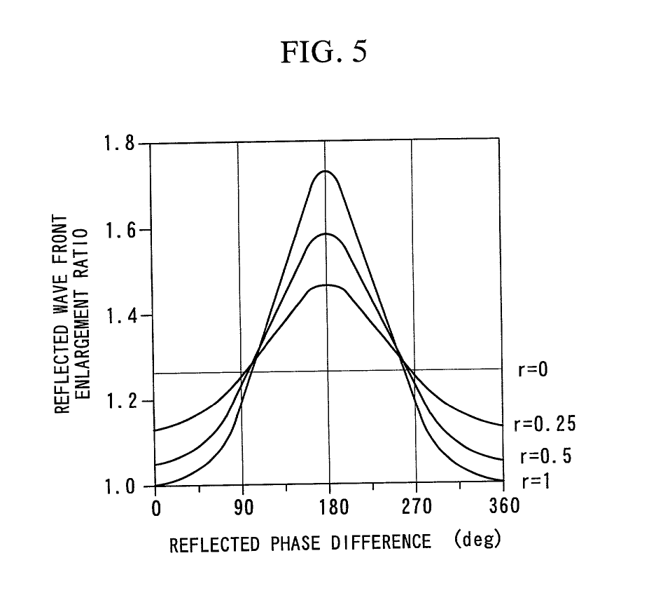

FIG. 5 is a graph showing an enlargement ratio of the reflected wave front from a test object, with respect to a reflection phase difference between the pinhole internal reflection and the pinhole external reflection, in the case where the pinhole diameter is 1 μm. Here, γ=pinhole internal reflectivity/pinhole external reflectivity, γ=0 corresponding to pinhole internal reflectivity=0, that is, the case where the light penetrates through the pinhole completely.

In this case, the desirable range of the reflected phase difference is as described below:

reflected phase difference=(−45 to 45°)+360°×integer;

0.5≦γ<1.

Under such conditions, the enlargement ratio of the reflected wave front resulting from scattering by the pinhole can be suppressed sufficiently, compared to the conventional pinhole.

Similarly, if the above conditions are satisfied, even in the case of a pinhole diameter of 1.5 μm, the enlargement ratio of the reflected wave front resulting from scattering by the pinhole can be suppressed to about ½, compared to the conventional pinhole.

In the case where the pinhole diameter is larger than that, it is necessary to decrease the NA of the collective lens, and increase the collecting spot diameter corresponding to the pinhole diameter, in order to remove the residual aberration of the collective lens 1. At this time, since the NA of luminous flux penetrating through the pinhole decreases, the NA on the measurable test surface decreases. If the NA on the test surface decreases, the collecting spot diameter of the luminous flux reflected on the test surface increases. As a result, distortion (=enlargement ratio) of the reflected wave front due to the pinhole scattering only occurs to the same extent as in the case where the pinhole diameter is 1 μm. Accordingly, also in this case, if the above conditional expression is satisfied, the enlargement ratio of the reflected wave front can be suppressed.

From FIG. 5, it is understood that it is necessary to determine γ, while considering the necessary light quantity, since the larger is γ, the larger is the effect, but if γ=1, light from the collective lens hardly penetrates through the pinhole, leading to insufficient light quantity. Also, from FIG. 5, it is understood that when the pinhole diameter is 0.5 μm or less, there is hardly any influence of disturbance in the reflected wave front due to such a reflected phase difference. Therefore, the above conditions become applicable in the range of the pinhole diameter of 0.5 μm or larger.

When the pinhole diameter is 1 μm, as the pinhole mirror satisfying the above conditions, there can be mentioned one in which a first reflection coating comprising chromium having a film thickness of 10 nm and a second reflection coating comprising chromium having a film thickness of 30 nm are sequentially formed on a glass substrate. In this example, if a light source having λ of 633 nm is used, the pinhole internal reflectivity (reflectivity of the first reflection coating) is about 26.5%, and the transmittance of the first reflection coating is about 35%. Also, the pinhole external reflectivity (reflectivity of the second reflection coating) is about 52.5%.

According to the PDI of the present invention, since the surface shape measurement becomes possible with precision as high as about 0.1 nmrms, it can be used for extra-precision measurement of a reflecting mirror for EUVL (Extreme Ultra Violet Lithography) which requires a profile irregularity of about 0.2 nmrms.

A case where a profile irregularity of a reflecting mirror for EUVL is measured using the PDI of the present invention will now be described. The reflecting mirror for EUVL has a multilayer film obtained by alternately laminating a heavy element layer and a light element layer on a substrate. As the substrate, there can be used a substrate of glass, fused quartz, silicon monocrystal, silicon carbide or the like, with the substrate surface polished so as to become sufficiently smooth, compared to the used wavelength. Moreover, as the heavy element layer, there can be used a thin film of, for example, scandium (Sc), titanium (Ti), vanadium (V), chromium (Cr), iron (Fe), nickel (Ni), cobalt (Co), zirconium (Zr), niobium (Nb), molybdenum (Mo), technetium (Tc), ruthenium (Ru), rhodium (Rh), hafnium (Hf), tantalum (Ta), tungsten (W), rhenium (Re), osmium (Os), iridium (Ir), platinum (Pt), copper (Cu), palladium (Pd), silver (Ag) or gold (Au). As the light element layer, there can be used a thin film of, for example, silicon (Si), carbon (C), beryllium (Be), silicon nitride (Si₃N₄), or boron nitride (BN).

In order to manufacture the reflecting mirror, when vacuum deposition in ultra-high vacuum or a compound material is used, a sputtering method in vacuum where the amount of residual oxygen is sufficiently low is used as an effective means, or various thin film forming methods such as resistance heating, CVD, or reactive sputtering methods may be used.

Reflecting mirrors which do not achieve the predetermined profile irregularity are machined again, and after a multilayer film has been formed, measurement of profile irregularity is performed. Until the predetermined profile irregularity is achieved, this step is repeated to manufacture the reflecting mirror.

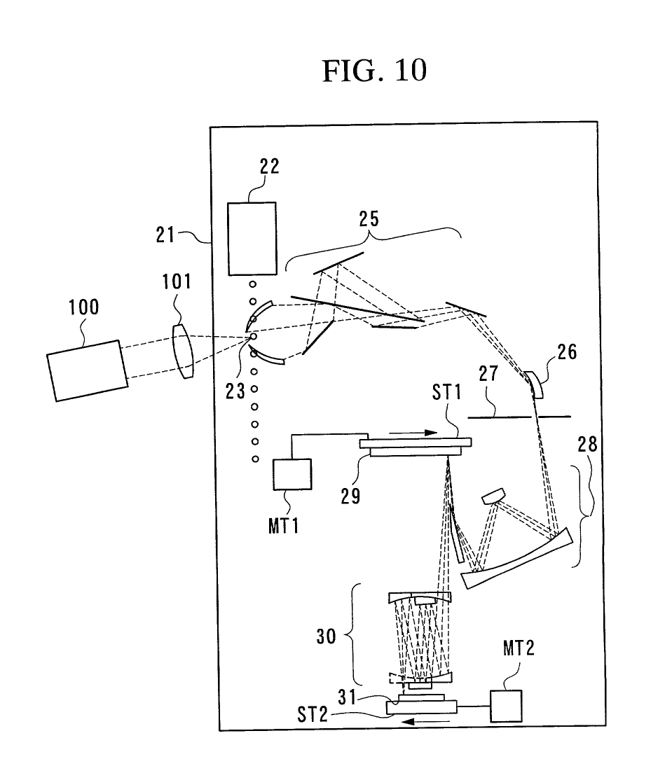

The reflecting mirror manufactured by such a manufacturing method is mounted on the EUVL shown in, for example, FIG. 10. FIG. 10 is a schematic diagram showing the construction of the EUVL In FIG. 10, laser radiation (from infrared rays to visible light) emitted from a laser light source 100 is collected to a collecting position 23 by means of a collective optical system 101. An object dripped from an object source 22 receives laser radiation having high illumination at the collecting position 23, and the center portion becomes a plasma, to generate soft X-rays, and becomes a light source of soft X-rays (plasma X-ray source).

Instead of the plasma X-ray source, SOR (Synchrotron Orbital Radiation) may be used. A wavelength region of 50 nm or less is desired, and for example, radiation light of 13 nm can be used. Moreover, since the soft X-rays have a low transmittance with respect to the air, the whole apparatus is covered with a vacuum chamber 21.

The soft X-rays generated at the collecting position 23 are guided onto a field stop 27 having a pattern of a predetermined area, by optical systems 25 and 26 comprising a combination of a plane mirror and a concave mirror. The radiated luminous flux having passed through the field stop 27 is guided onto a reflective mask 29 placed on a mask stage ST1, by a relay optical system 28 composed of a reflection system. On this reflective mask 29 is formed a pattern comprising a reflecting portion for reflecting the soft X-rays and a non-reflecting portion which does not reflect the soft X-rays. The optical systems 25, 26 and 28 constitute an illumination optical system for illuminating on the reflective mask 29.

The radiated luminous flux selectively reflected by the reflective mask 29 is guided to a substrate to be exposed 31 placed on a substrate stage ST2, by a projection optical system 30, so that a pattern on the reflective mask 29 is projected onto the substrate to be exposed 31.

The mask stage ST1 and the substrate stage ST2 are respectively connected to drive sections MT1 and MT2, and at the time of exposure, the reflective mask 29 and the substrate to be exposed 31 are relatively moved with respect to the projection optical system 30, as shown by the arrows in FIG. 10, thereby enabling scanning exposure. Here, the field stop 27 and the mask 29 are in a conjugate relation with regard to the relay optical system 28. Moreover, the field stop 27 and the substrate to be exposed 31 are in a conjugate relation with regard to the relay optical system 28, the reflective mask 29 and the projection optical system 30.

Therefore, this is optically equivalent to the case where a field stop 27 is arranged on the mask 29, and hence the illumination range can be limited. According to such a construction, since the field stop 27 does not exist in the vicinity of the mask 29, disturbance of radiated luminous flux due to the stop 27 does not occur, and hence an image having a high resolution can be obtained. Moreover, when the projection optical system 30 forms an intermediate image of the reflective mask 29 therein, the field stop 27 may be arranged at the intermediate image position.

The field stop is not limited to being one, and may be constituted of a plurality of members, such as a blade for limiting the width of the scanning orthogonal direction and a blade for limiting the width of the scanning direction.

All the reflecting mirrors mounted for EUVL, shown in FIG. 10 are preferably reflecting mirrors having a high precision surface manufactured by the above-described manufacturing method. However, needless to say, the configuration of the EUVL for which the reflecting mirrors manufactured by this manufacturing method are mounted is not limited to this example. For example, as other examples of EUVL, there can be mentioned U.S. Pat. Nos. 5,815,310, 5,410,434, 5,353,332, 5,220,590, 5,153,898, 5,093,586 and the like. Moreover, so long as domestic laws permit countries where applications with a claim of priority have been filed based on this patent application, the disclosure in the above U.S. patents is incorporated herein as a part of this application.

It is of course possible to use the PDI of the present invention for extra-precision measurement of reflecting mirrors, other than the mirrors for EUVL.

What is claimed is:

1. A point diffraction interferometer which measures a profile irregularity of a surface to be measured by, irradiating light irradiated from a light source to a pinhole mirror via a collective optical system, irradiating a part of the light diffracted from a pinhole provided in the pinhole mirror to said surface to be measured as a luminous flux for measurement, making said luminous flux for measurement reflected by the surface to be measured interfere with a reference luminous flux which is an other part of light diffracted from said pinhole, and detecting the state of an interference fringe caused by the interference, wherein
a diameter range of said pinhole is:
λ/2≦φPH≦λ/NA,
wherein λ is a wavelength of light irradiated from said light source, NA is a numerical aperture of said collective optical system, and φ PH is a diameter of said pinhole.

2. A point diffraction interferometer which measures a profile irregularity of a surface to be measured by, irradiating light irradiated from a light source to a pinhole mirror via a collective optical system, irradiating a part of the light diffracted from a pinhole provided in the pinhole mirror to said surface to be measured as a luminous flux for measurement, making said luminous flux for measurement reflected by the surface to be measured interfere with a reference luminous flux which is an other part of light diffracted from said pinhole, and detecting the state of an interference fringe caused by the interference, wherein
a range of a numerical aperture of said collective optical system is:
NA≦λ/φPH,
0<NA<1,
wherein λ is a wavelength of light irradiated from said light source, NA is a numerical aperture of said collective optical system, and φ PH is a diameter of said pinhole.

3. A point diffraction interferometer which measures a profile irregularity of a surface to be measured by, irradiating light irradiated from a light source to a pinhole mirror via a collective optical system, irradiating a part of the light diffracted from a pinhole provided in the pinhole mirror to said surface to be measured as a luminous flux for measurement, making said luminous flux for measurement reflected by the surface to be measured interfere with a reference luminous flux which is an other part of light diffracted from said pinhole, and detecting the state of an interference fringe caused by the interference, wherein the light irradiated onto said pinhole is elliptically polarized light, and
0.5<ε<2,
wherein ε is ellipticity (ratio of a minor axis to a major axis).

4. A point diffraction interferometer which measures a profile irregularity of a surface to be measured by, irradiating light irradiated from a light source to a pinhole mirror via a collective optical system, irradiating a part of the light diffracted from a pinhole provided in the pinhole mirror to said surface to be measured as a luminous flux for measurement, making said luminous flux for measurement reflected by the surface to be measured interfere with a reference luminous flux which is an other part of light diffracted from said pinhole, and detecting the state of an interference fringe caused by the interference, wherein
said pinhole mirror has a transparent substrate, a first reflection coating and a second reflection coating comprising said pinhole, formed sequentially on this substrate.

5. A point diffraction interferometer according to claim 4, wherein when said pinhole diameter is 0.5 μm or larger:
0.5≦γ<1;
φ=Δ+360°×N(−45°≦Δ≦45°, N=integer),
wherein γ is internal reflectivity of said pinhole (reflection by the first reflection coating)/external reflectivity of said pinhole (reflection by the second reflection coating), and φ is a phase difference between the internal reflectivity and the external reflectivity of said pinhole.

6. A point diffraction interferometer which measures a profile irregularity of a surface to be measured by, irradiating light irradiated from a light source to a pinhole mirror via a collective optical system, irradiating a part of the light diffracted from a pinhole provided in the pinhole mirror to said surface to be measured as a luminous flux for measurement, making said luminous flux for measurement reflected by the surface to be measured interfere with a reference luminous flux which is an other part of light diffracted from said pinhole, and detecting the state of an interference fringe caused by the interference, wherein
a dielectric multilayer reflection coating is formed on said surface side to be measured of said pinhole mirror.

7. A point diffraction interferometer which measures a profile irregularity of a surface to be measured by, irradiating polarized light irradiated from a light source to a polarization retention fiber, irradiating a part of the polarized light emitted from this fiber to said surface to be measured as a luminous flux for measurement, making said luminous flux for measurement reflected by said surface to be measured interfere with a reference luminous flux which is an other part of polarized light emitted from said fiber, and detecting the state of an interference fringe caused by the interference, wherein
a λ/2 plate comprising a rotation mechanism is arranged between said light source and the polarization retention fiber.

8. A point diffraction interferometer which measures a profile irregularity of a surface to be measured by, irradiating light irradiated from a light source to a single-mode fiber, irradiating a part of the light emitted from this fiber to the surface to be measured as a luminous flux for measurement, making said luminous flux for measurement reflected by said surface to be measured interfere with a reference luminous flux which is an other part of polarized light emitted from said fiber, and detecting the state of an interference fringe caused by the interference, wherein
a dielectric multilayer reflection coating is formed on an end face on said surface side to be measured of said single-mode fiber.

9. A manufacturing method for a reflecting mirror in which a multilayer film obtained by alternately laminating a heavy element layer and a light element layer on a substrate is formed,
comprising at least a step for measuring a profile irregularity, using a point diffraction interferometer according to any one of claim 1 through claim 8.

10. A projection exposure apparatus comprising an illumination optical system which illuminates a mask by soft X-rays, and a projection optical system which projects a pattern formed on said mask onto a photosensitive substrate for exposure, wherein
said illumination optical system or said projection optical system comprises the reflecting mirror manufactured by the manufacturing method for a reflecting mirror according to claim 9.
